(19) United States
(12) Patent Application Publication
(10) Pub. No.: US 2025/0145248 A1
(43) Pub. Date: May 8, 2025

(54) DRIVE DEVICE FOR AN ELECTRIC BICYCLE AND ELECTRIC BICYCLE

(71) Applicant: Porsche eBike Performance GmbH, Ottobrunn (DE)

(72) Inventor: Julius Thorwart, Ottobrunn (DE)

(21) Appl. No.: 18/837,579

(22) PCT Filed: Feb. 13, 2023
(86) PCT No.: PCT/EP2023/053452

§ 371 Date: Aug. 9, 2024

(30) Foreign Application Priority Data
Feb. 16, 2022 (DE) 10 2022 103 634.0

(51) Int. Cl. B62M 6/65; B62J 45/411; B62J 45/423; H02K 9/22; H02K 13/00

(52) U.S. Cl. CPC B62M 6/65; B62J 45/411; B62J 45/423; H02K 9/227; H02K 13/003

(57) ABSTRACT

In an embodiment a drive device includes a motor unit with an electric motor configured to drive an electric bicycle, a hub axle coupled to the electric motor, a gearbox, which is configured to drive the electric bicycle and is rotatable about an axis of rotation, and which is coupled to the electric motor and to the hub axle and is configured to output a torque for driving the electric bicycle, and a motor housing, in which the electric motor and the gearbox are arranged and through which the hub axle extends, the electric motor being shielded by an adjacent wall of the motor housing, which extends into an outer region outside the motor housing so that heat generated by the electric motor during operation of the electric bicycle is dissipated to the outer region by direct heat conduction through the wall.

### CROSS-REFERENCE TO RELATED APPLICATIONS

This patent application is a national phase filing under section 371 of PCT/EP2023/053452, filed Feb. 13, 2023, which claims the priority of German patent application 102022103634.0, filed Feb. 16, 2022, each of which is incorporated herein by reference in its entirety.

### TECHNICAL FIELD

The invention relates to a drive device for an electric bicycle and an electric bicycle with such a drive device.

### BACKGROUND

Bicycles realize inexpensive, easy-to-handle and emission-free means of transportation. They have also found widespread use as sports or fitness equipment, and particularly suitable types have emerged for various fields of application.

In recent years, enthusiasm for electric bicycles, especially so-called “pedelecs”, has been growing, despite the high weights and prices for bicycles. Potential customers are not only older, less fit cyclists or those without sporting ambitions, but also sporty, younger riders, whether for use on the way to work or because of the possibility of using them to extend their range of action and/or increase their travel speed without overstressing their own physique. Interest in electrically assisted mountain bikes seems to be growing, especially among mountain bikers. In the case of electric bikes, it is important to provide a reliable supportive drive system that enables high power transmission.

### SUMMARY

Embodiments provide a reliable drive concept for electric bicycles, which enables a clear structure and also contributes to a high power transmission.

According to an embodiment, a drive device for an electric bicycle is disclosed. The drive device has a motor unit with an electric motor for driving the electric bicycle. The drive device further comprises a hub axle coupled to the electric motor. The drive device further comprises a gearbox which is designed to drive the electric bicycle and is rotatable about an axis of rotation and which is coupled on the one hand to the electric motor and on the other hand to the hub axle. The gearbox is designed to output a torque to drive the electric bicycle. The drive device also has a motor housing in which the electric motor and the gearbox are arranged and through which the hub axle extends. The electric motor is shielded by an adjacent wall of the motor housing, which extends into an outer area outside the motor housing, so that heat generated by the electric motor during operation of the electric bicycle can be dissipated to the outer area by means of direct heat conduction through the wall.

A reliable drive concept for electric bicycles can be realized by means of the drive device described, which in particular enables an efficient rear wheel hub drive. Due to the heat that can be dissipated directly by means of heat conduction, a structure of the drive device is provided which can contribute to an increased continuous output of the electric motor. The drive device described is particularly suitable as an electric bicycle drive system for mounting on a bicycle hub or a rear wheel of the electric bicycle.

It is a finding that conventional drive systems for electric bicycles are generally hermetically sealed in order to protect them from dirt and splash water, among other things. However, this creates an encapsulated structure that prevents a cooling flow. Instead, the encapsulated structure contributes to the heat accumulating or at least only being dissipated relatively slowly, which can have a detrimental effect on the operation of the drive system and its service life. By means of the described design of the drive device and the possibilities for direct heat dissipation by means of heat conduction built into it, reliable and prompt cooling can be achieved, which has a beneficial effect on the continuous performance of the electric motor.

According to an embodiment of the drive device, the wall of the motor housing borders directly on the outer area, so that the electric motor is only shielded from the outer area by a single wall of the drive device. For example, the electric motor is shrunk directly into the motor housing and contacts the wall or has a heat-conducting intermediate element that connects the electric motor to the wall. In this way, any heat generated can be dissipated in a controlled and timely manner by means of heat conduction through the material of the wall and, if applicable, the connecting intermediate element, and transferred to the outside area or absorbed by the ambient air in the outside area.

According to a further embodiment of the drive device, the wall of the motor housing has an extension section that connects the wall to the outer area in a thermally conductive manner. A continuous material guide for the heat conduction from the wall surrounding the electric motor to the outer area outside the motor housing can also be set up by means of such a specifically introduced extension section.

The electric motor comprises, for example, a rotor and a stator and the stator is arranged in direct proximity to the wall of the motor housing. In particular, the stator forms a component of the electric motor which generates a relatively large amount of heat during operation and is therefore preferably located in the vicinity of a heat-dissipating wall. The rotor and/or the stator of the electric motor can be arranged on the wall of the motor housing or connected to it by means of an intermediate element, so that material-guided heat conduction is established through the wall to the outer area. Such material-guided heat conduction is preferably designed as a single piece. Alternatively, the wall and the other heat-conducting elements, which are connected to the wall, in particular without air, can form a continuous heat conduction without an air gap between them.

It is a finding that in a conventional drive system for electric bicycles, the available installation space is predetermined and relatively limited, for example by a brake disk on one side and by a chainring system on the other side. Within such an installation space, the interacting components are tightly packed in an axial and radial direction and are usually deliberately encapsulated to take up as little installation space as possible.

For example, a conventional drive system comprises an electric motor with an external rotor and an internal stator, so that an external rotor drive is realized with regard to the rotation of the components. The stator is then, for example, permanently mounted on an axle and arranged together with the rotor and permanent magnets in a rotor bell and a housing. The stator usually forms a main heat source, which is therefore very strongly encapsulated and installed very far away from external housing components.

Alternatively, in a conventional drive system, the stator can be fixed in a surrounding bell housing, while the rotor rotates inside with permanent magnets. In such an internal rotor drive, the stator as the main heat source is arranged closer to the external housing components, but is still installed in a highly encapsulated manner. In addition, there is an air gap between the bell housing and an outer housing of the drive system, which enables comparatively poor heat transfer and acts as a heat insulator.

The relatively tightly packed conventional designs described above mean that heat dissipation, especially from active parts of the drive system, to the housing parts around which the ambient air flows only takes place in a roundabout way, which often involves penetrating several different material walls and/or internal air gaps. Such reduced cooling of the active parts can mean that the power of the motor unit of the electric bicycle has to be reduced after a short time in order to avoid permanent damage to the drive system.

By means of the drive device described and the direct heat conduction to the outside made possible therein, heat from the electric motor can be dissipated promptly and in a directed manner, and a significantly higher continuous output of the electric motor and the drive device can be achieved. This is achieved in particular by avoiding or at least significantly reducing heat-insulating air gaps and/or passages through several different material walls. The drive device thus provides heat dissipation, in particular on the basis of heat conduction through a material. A sum of thermal resistances and/or transitions as well as a length of a heat-dissipating transfer path can be deliberately kept low by means of the drive device described.

The electric motor usually has a relatively good efficiency at room temperature. During operation, one winding of the electric motor is energized to generate the torque. Due to various loss mechanisms, such as copper losses, iron losses, eddy current losses, hysteresis losses, friction losses and flow losses, a certain amount of power loss in the form of heat occurs during operation. The heat generated is dissipated in order to keep the efficiency of the electric motor at a constant level.

If the heat is not dissipated or is dissipated insufficiently, the electric motor heats up, especially its active parts, such as the stator. The increase in temperature in the winding therefore results in self-amplification. The efficiency deteriorates as the temperature rises and the power loss increases. If the heat is not dissipated or is dissipated inadequately, this can lead to damage to the electric motor. In addition, the efficiency of the electric motor is significantly dependent on its operating point. At unfavorable operating points, for example at relatively high torque and low speed, as is the case when driving uphill, operation is usually not very efficient.

According to an embodiment of the drive device, the wall has a cooling structure comprising a plurality of ribs which are arranged at a distance from each other on an outer side of the wall. The ribs form a predetermined surface enlargement of the outer side of the wall, which faces the outer area. This allows the drive device to be cooled even more efficiently by ambient air.

According to an embodiment of the drive device, the motor housing comprises a rotating housing section which is rotatably coupled to the hub axle and in which the electric motor is arranged in direct proximity to the wall of the motor housing. During operation of the drive device, the rotating housing section rotates about the axis of rotation, which in particular also corresponds to an axis of symmetry or longitudinal axis of the hub axle, while the electric bicycle is being ridden. The hub axle is stationary or rotationally fixed relative to the rotatable housing section and serves in particular to hold the components and attach the drive device to the electric bicycle.

According to an embodiment, the drive device has a slip ring which is arranged within the motor housing with respect to the axis of rotation. The slip ring comprises a first slip ring element and a second slip ring element, which contact each other radially and/or axially in relation to the axis of rotation. One slip ring element is fixedly coupled to the hub axle and therefore does not rotate around the axis of rotation. The other slip ring element is rotatably coupled to the hub axle and therefore rotates around it and around the axis of rotation. The slip ring elements are coupled to the stator in order to provide a power supply to the stator to generate torque when the electric bicycle is in operation. The use of a slip ring is particularly suitable for a design in which the stator is connected directly to the motor housing in order to enable improved heat dissipation. For example, the stator is shrunk into the circumferential housing section of the motor housing.

In this way, an energy supply to the stator can be established even if both components of the electric motor, the stator and the rotor, rotate around the axis of rotation. Alternatively, the stator can be coupled to the hub axle or the motor housing in a rotationally or stationary manner, so that direct wiring of the stator to the power supply can be established and the installation of a slip ring can be dispensed with.

According to a further embodiment of the drive device, the motor housing includes two parts and comprises a rotating housing section and a stator cover, which are rotatably coupled to each other with respect to the axis of rotation by means of a bearing. The housing section is rotatable and surrounds the stator cover, which is coupled to the hub axle in a rotationally fixed or stationary manner. The housing section has an axial opening through which the stator cover extends axially along the axis of rotation to the outside of the housing section. In this way, the stator cover with the stator or electric motor inside can be moved closer to the outer area and thus be better cooled. The electric motor is therefore not insulated and shielded from the outside area by a stator cover and a housing and any elements and/or air gaps arranged between them, but can instead transfer heat promptly and effectively to the wall of the stator cover, which in turn conducts the heat to the outside area by means of heat conduction and releases it to the ambient air.

In addition, the drive device can include a brake disk for braking the electric bicycle as required, which is firmly coupled to the circumferential housing section. The brake disk then preferably has an axial or inner penetrating recess through which the stator cover extends axially along the axis of rotation. The stator cover can thus extend through the housing section and through the brake disk into the outer area and enable reliable cooling of the electric motor, which usually forms the main heat source of the drive device. The stator cover and the electric motor are thus axially displaced and therefore also provide available installation space in the housing section, which can be used for other components of the drive device.

According to a further embodiment of the drive device, the hub axle has a first and a second end section in relation to the axis of rotation, which are set up to be coupled to a respective outer frame element on opposite sides in relation to the axis of rotation. The second end section is narrower than the first section. For example, in relation to a radial direction transverse to the axis of rotation, the second end section has a diameter that is at least one millimeter smaller than a diameter of the first end section. For example, the first end section is designed as an M12 section and the second end section as an M10 section, so that the hub axle tapers from a diameter of 12 mm to a diameter of 10 mm. Alternatively, other diameter values can also be provided so that at least one end section is narrower than the other.

The end sections can have threads and be screwed to the associated frame elements. Alternatively or additionally, separate threaded elements, for example as steel inserts, can be provided between the hub axle and the frame elements, which enable the components of the drive device to be reliably connected and tensioned. By designing the hub axle in such a way that it tapers and has a narrower second end section, installation space can be provided that is suitable for a torque sensor, for example.

According to a further embodiment, the drive device comprises a cassette body which is coupled to the motor housing and which is the hub axle in relation to the axis of rotation. The cassette body is designed to transmit a torque of a rider of the electric bicycle to the hub axle. The drive device also has a sensor unit which is coupled to the hub axle to determine a torque of the rider and is arranged between the cassette body and the hub axle in relation to a radial direction transverse to the axis of rotation. The sensor unit can comprise a torque sensor and enable a power measurement that is linked to the operation of the electric motor or processed to provide a reliable and efficient electric bicycle drive.

Preferably, the sensor unit is arranged in the narrower second end section of the hub axle and the sensor unit and the second end section are designed to match each other. For example, a narrow installation space is available so that the sensor unit is designed in the shape of a plate and/or ring in order to be arranged reliably and stably in the narrow installation space. Alternatively, the sensor unit can have a certain shape, so that the second end section of the hub axle is particularly narrow and, for example, made of a particularly stable material in order to accommodate the sensor unit and also to provide the required stability of the drive device.

According to a further embodiment of the drive device, the hub axle includes two parts and comprises a thru axle and a sleeve-shaped drive axle through which the thru axle extends. The thru axle can also be sleeve-shaped or hollow. In particular, the quick-release axle is longer than the drive axle surrounding it, so that it protrudes from both sides of the drive axle. In this way, the quick-release axle can be coupled to the frame elements, in particular bolted, and the drive axle can be pretensioned. The drive axle serves in particular as a stabilizing holding element for the surrounding components of the drive device. In addition, the hub axle can also have a three-part, four-part or multi-part design and have elements that can be plugged into each other or coupled to each other.

For example, the drive device has a first and a second frame element, which are arranged on opposite sides outside the motor housing in relation to the axis of rotation and surround the hub axle at least in sections. The two frame elements are arranged and designed in such a way that they predeterminedly brace the drive axle in cooperation with the thru axle.

If the hub axle is designed in two or more parts, the thru axle and the drive axle are preferably tapered along the axis of rotation in the direction of the second end section of the hub axle.

According to a further embodiment of the drive device, the gearbox is designed as a planetary gearbox with a sun gear and at least one planetary gear and is arranged coaxially around the hub axle with respect to the axis of rotation of the hub axle, so that the planetary gearbox surrounds the hub axle.

Preferably, the electric motor is also designed as a ring motor and is arranged coaxially around the hub axle in relation to its axis of rotation, so that the ring motor surrounds the hub axle. The hub axle can form a bearing seat for the planetary gear and/or the ring motor. In this way, one or both components can be arranged radially and in a particularly space-saving manner, for example by coupling them to the hub axle using ball bearings and/or roller bearings.

With regard to the designs of the gearbox as a planetary gearbox and the motor unit as a ring motor, these components can be plugged or pushed onto the drive axle before the plug-in axle is passed through, so that an assembly can be provided and subsequently coupled to the bicycle frame. Accordingly, a method for manufacturing the drive device can include providing and coupling the respective components. For example, the electric motor is pushed onto the drive axle as a ring motor and the planetary gear is then also arranged axially adjacent to it. The assembly can then be placed on the rear bicycle tire and the quick-release axle inserted through it and bolted to the frame elements. Alternatively, a different order of assembly can also be carried out, so that, for example, the quick-release axle is first inserted through the drive axle or the assembly, thereby forming the drive device, which is then bolted to the frame elements by means of the end sections of the quick-release axle.

The described embodiments of the drive device each enable a reliable and efficient electric drive system for a rear wheel hub drive of an electric bicycle. In particular, reliable heat dissipation by means of heat conduction and an enlarged axial installation space can be realized. In addition, the two-piece hub axle can improve the rigidity of the drive device and customer acceptance by using the quick-release axle.

According to a further embodiment, an electric bicycle is disclosed which has a bicycle frame extending to a bottom bracket and to a bicycle hub. The electric bicycle has a drive device according to one of the previously described embodiments, which is arranged in or on the bicycle hub, so that a torque for driving the electric bicycle can be transmitted by means of the gearbox. The electric bicycle essentially enables the aforementioned features, advantages and functions.

For attachment to the bicycle hub and possibly to a frame section of the electric bicycle, the latter has a recess, for example, so that the drive device can be reliably accommodated. According to an embodiment, the drive device is, for example, arranged as an assembly in the already coupled state on the bicycle hub, in particular mounted, or forms it.

### BRIEF DESCRIPTION OF THE DRAWINGS

Embodiments, advantages and functions are explained in the following description using examples of embodiments with the aid of the attached figures.

FIG. 1 shows a schematic view of an electric bicycle with a mounted drive device;

FIGS. 2-4 show an embodiment of the drive device for the electric bicycle in various views;

FIGS. 5-8 show a further embodiment of the drive device for the electric bicycle in various views; and

FIGS. 9-11 show a further embodiment of the drive device for the electric bicycle in various views.

Identical, similar or similarly acting elements are provided with the same reference signs in the figures. For reasons of clarity, not all of the elements shown are marked with the corresponding reference symbols in all of the figures, possibly.

### DETAILED DESCRIPTION OF ILLUSTRATIVE EMBODIMENTS

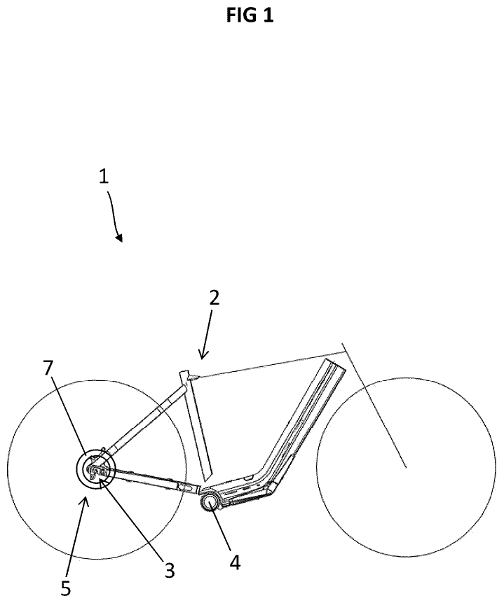

FIG. 1 schematically shows an electric bicycle 1 with a bicycle frame 2, which extends in the direction of a bottom bracket 4 and in the direction of a rear bicycle hub 3. The bicycle hub 3 is coupled or can be coupled to an electric drive device 5 for the electric bicycle 1.

Terms such as “front”, “rear”, “top”, “bottom”, “right”, “left”, “outside” and “inside” refer to alignments or orientations of respective components as illustrated in the figures and as they are arranged in an operational state of the electric bicycle 1. The electric bicycle 1 generally has a front wheel and a rear wheel. An outer area refers to an area outside the electric bicycle 1 or outside the drive device 5. The drive device 5 can also be referred to as a rear wheel hub drive and is integrated in or arranged on the rear bicycle hub 3 and transmits a provided drive force to the bicycle hub 3 almost loss-free. The wheels of the electric bicycle 1 are set in motion directly by the drive device 5, so that a high degree of efficiency can be achieved by means of the rear wheel hub drive to support a rider of the electric bicycle 1.

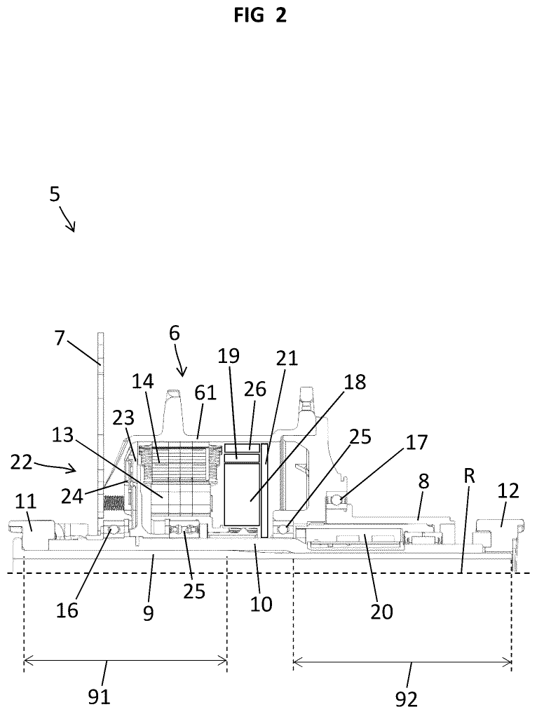

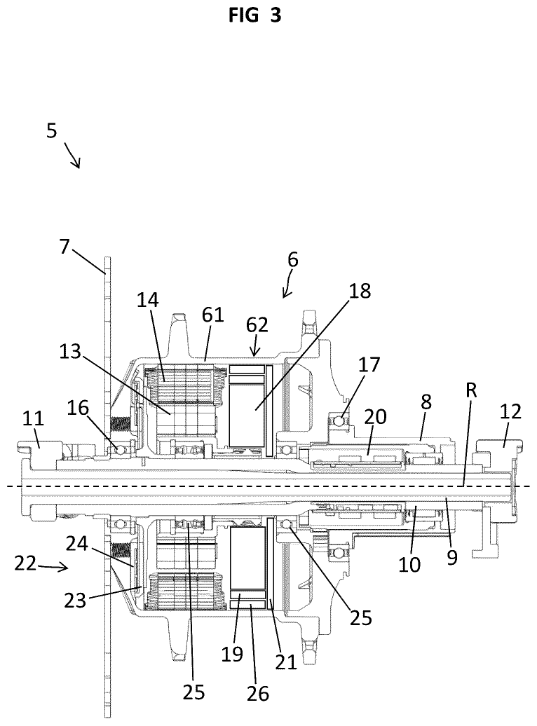

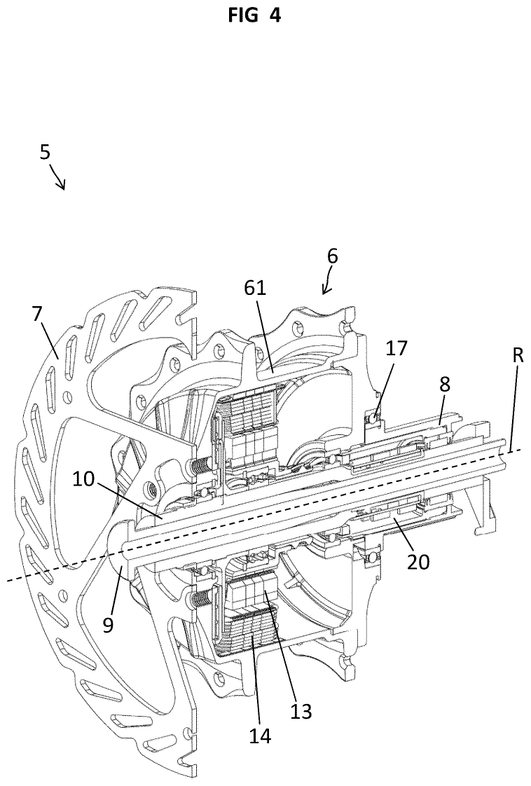

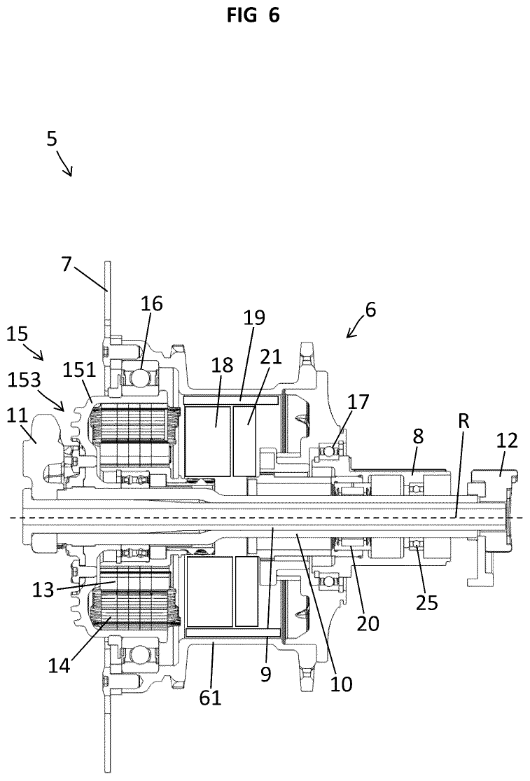

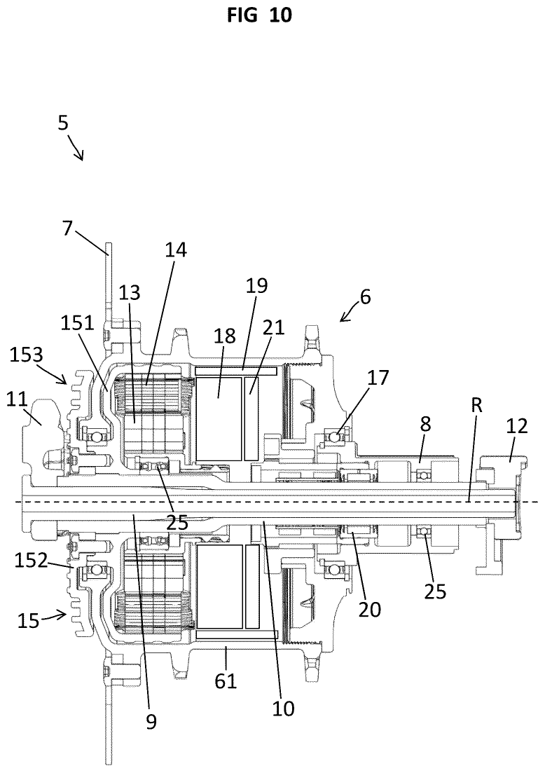

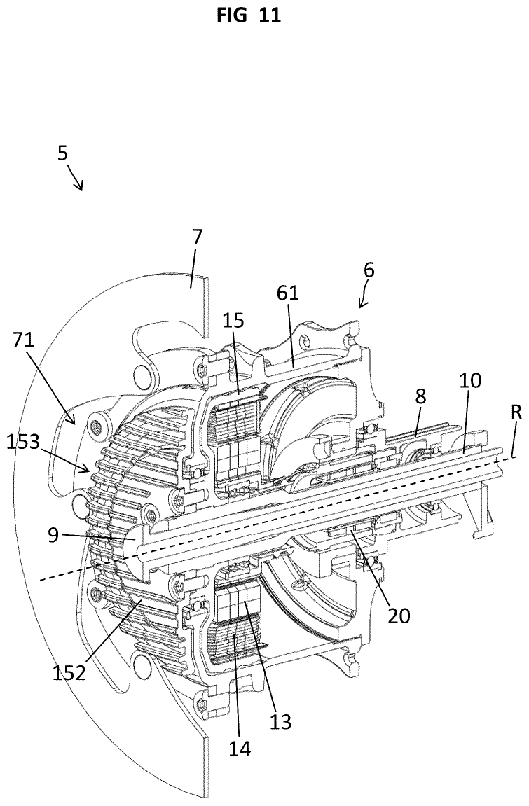

As explained with reference to the following embodiments and FIGS. 2-11, the drive device 5 enables a drive concept for electric bicycles that has a clear structure and also contributes to a high power transmission.

FIGS. 2-4 schematically show an embodiment of the drive device 5 for the electric bicycle 1 in various views. The drive device 5 comprises a motor unit with an electric motor for driving the electric bicycle 1. The electric motor is designed as a ring motor with respect to an axis of rotation R and has a rotor 13 and a stator 14, which provide a drive torque in rotational interaction. In relation to the axis of rotation R, the rotor 13 is arranged radially inwards and the stator 14 radially outwards within a motor housing.

The drive device 5 also has a hub axle, which is formed in two parts and comprises a thru axle 9 and a drive axle 10, which are coupled to the electric motor. The thru axle 9 and the drive axle 10 are sleeve-shaped and the thru axle 9 extends through the drive axle 10, so that respective end sections 91, 92 of the thru axle 9 protrude from the drive axle 10.

The drive device 5 further comprises a gearbox which is designed to drive the electric bicycle 1 and is mounted to rotate about the axis of rotation R. The gearbox is preferably designed as a planetary gearbox 18 and is arranged axially adjacent to the electric motor in the motor housing. The planetary gear 18 comprises a sun gear and at least one planet gear and can also be coupled to a ring gear 19, a planet carrier 21 and/or a freewheel 26 or have such components. The planetary gear 18 is coupled on the one hand to the electric motor and on the other hand to the hub axle and is set up to output a torque for driving the electric bicycle 1.

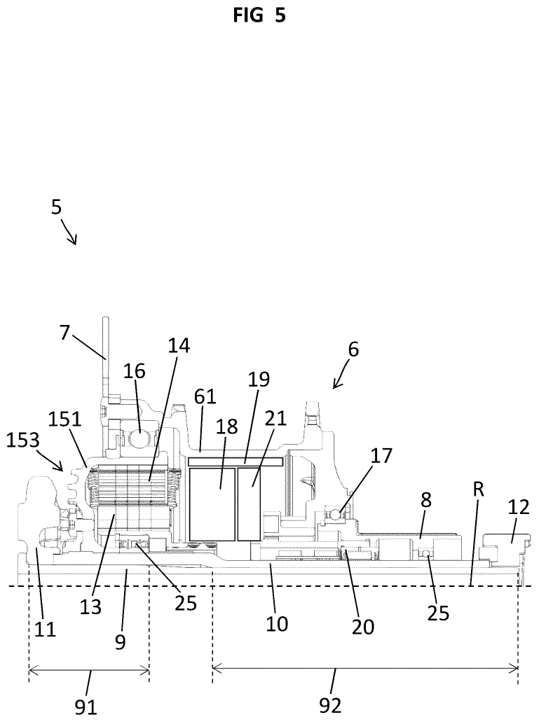

The drive device 5 also comprises the motor housing, which comprises a circumferential housing section 6 and possibly also a stator cover 15 (see FIGS. 5-11). According to FIGS. 2-4, the rotor 13, the stator 14 and the planetary gear 18 are arranged in the housing section 6. The hub axle with the plug-in axle 9 and the drive axle 10 extends through the housing section 6. The electric motor and in particular the stator 14 are only shielded from the outer area by an adjacent wall 61 of the housing section 6. An outer side 62 of the wall 61 thus adjoins the outer area at least in sections and can be directly surrounded by ambient air. This means that heat generated by the electric motor during operation of the electric bicycle 1 can be conducted directly through the wall 61 to the outer area and dissipated to the ambient air by radiation and convection. The heat can then also be dissipated from the housing into the spokes by means of heat conduction.

The stator 14 is shrunk directly into the circumferential housing section 6 in the rear wheel hub drive. The direct connection of the stator 14 to the housing section 6 enables particularly reliable and prompt heat dissipation through heat conduction to the motor housing and thus to the circulating air in the outer area. The stator 14 is also supplied with a three-phase three-phase current by means of a slip ring 22 for generating a torque. The slip ring 22 comprises a first and a second slip ring element 23, 24, which make axial and/or radial contact with respect to the axis of rotation R. The power supply to the stator 14 is thus transmitted from the stationary drive axle 10 to the rotating housing section 6 and then to the stator 14. In other embodiments, installation of a slip ring 22 can be dispensed with and a direct cabling to the power supply of the stator 14 can be set up (see FIGS. 5-11). A power supply by means of the slip ring 22 is suitable if, as shown in FIGS. 2-4, both the rotor 13 and the stator 14 are rotatable about the axis of rotation R.

The rotor 13 is mounted on the stationary or rotationally fixed drive shaft 10 by means of one or more bearings 25 and transmits a drive torque to the downstream planetary gear 18. The planetary gear 18 converts speed and torque and the converted torque can be transmitted to the rotating housing section 6 either through the planet carrier 21 or through the ring gear 19, with a drive by the sun gear. The freewheel 26 for decoupling a drive train during operation of the electric bicycle 1 without support from the electric motor can also be provided between the output, which is set up by the ring gear 19 and/or the planet carrier 21, and the rotating housing section 6.

The drive device 5 further comprises a brake disk 7 on one side and a cassette body 8 on the other side of the drive device 5 in relation to the axial arrangement of the components along the axis of rotation R. The brake disk 7 is used to brake the electric bicycle 1 and is firmly coupled, for example screwed, to the circumferential housing section 6. The cassette body 8 is coupled to the rotating housing section 6 as a sprocket carrier by means of a second main bearing 17. In relation to the axis of rotation R, the cassette body 8 surrounds the drive axle 10 and the plug-in axle 9 and is designed to transmit a torque of a rider of the electric bicycle 1 to the motor housing. The drive torque of the rider is transmitted through the cassette body 8 into the circumferential housing section 6. The cassette body 8 also contains or surrounds a sensor unit 20 of the drive device 5, which comprises sensor technology for measuring the rider's torque. The sensor unit 20 is arranged in relation to a radial direction transverse to the axis of rotation R between the cassette body 8 and the drive axle 10. This can be made possible, in particular in a space-saving manner, by the hub axle tapering towards the second end section 92 with the plug-in axle 9 and the drive axle 10. The cassette body 8 can also be decoupled from the circumferential housing section 6 by a freewheel.

The sensor unit 20 is based, for example, on a magnetostrictive measuring principle. The measuring sleeve is made of steel, for example, and is permanently magnetized. Alternatively, it can also be ferromagnetic and can be electrically magnetized by a coil. The measuring sleeve is twisted by a torsional moment so that the magnetic field in the measuring sleeve changes. Such a change in the magnetic field is proportional to the torque and can be detected using coils in the sensor electronics.

The sensor unit 20 is arranged in relation to a radial direction transverse to the axis of rotation R between the cassette body 8 and the drive axle 10. This can be made possible, in particular in a space-saving manner, by the hub axle tapering towards the second end section 92 with the plug-in axle 9 and the drive axle 10. The cassette body 8 can also be decoupled from the circumferential housing section 6 by a freewheel. The freewheel is realized, for example, as a pawl free wheel or a toothed disc freewheel.

The quick-release axle 9 is designed to be coupled, in particular bolted, at opposite ends to outer frame elements 11 and 12 of the bicycle frame 2 of the electric bicycle 1. Between the two frame elements 11 and 12, the fixed drive axle 10 is provided on the drive side, on which both the circumferential housing section 6 is mounted by means of two main bearings 16 and 25, as well as the rotor 13 and the cassette body 8. The fixed drive axle 10 is designed in such a way that it provides the necessary rigidity to support the forces acting on it during operation.

The circumferential housing section 6 is mounted on the drive axle 10 by means of two bearings 16, 17 or 25. These bearings can also be referred to as main bearings and other bearings as additional bearings. In FIGS. 2-4, the bearing 16 on the illustrated left-hand area of the housing section 6 and the bearing 25 on the illustrated right-hand area of the housing section 6 can therefore be referred to as the main bearing. Technically, the bearings 16, 17 and 25 are designed to act in the same way in particular and experience position-dependent forces and/or serve position-dependent functions essentially due to their installation position in the drive device 5.

The fixed drive axle 10 is hollow so that there is space inside for the thru axle 9, which is screwed into the right-hand dropout or, by means of the narrower second end section 92, into the second frame element 12 of the bicycle frame 2 and thus braces the two frame elements 11, 12 against the fixed drive axle 10. The thru axle 9 is not designed with a uniform diameter, but tapers towards the right-hand dropout in order to provide installation space for the sensor unit 20.

By means of the drive device 5, efficient and directional heat dissipation and also a useful axle standard can be provided, which can have an advantageous effect on rigidity and customer acceptance by using the two-part hub axle with the plug-in axle 9 and the drive axle 10.

FIGS. 5-8 schematically show a further embodiment example of the drive device 5 for the electric bicycle 1 in various views. According to this embodiment example, the motor housing comprises, in addition to the circumferential housing section 6, a stator cover 15, which are coupled together by means of a first bearing 16. Compared to the previous embodiment example, a diameter of the left-hand or first bearing 16 is significantly larger. The first bearing 16 can also be referred to as the first main bearing and is arranged on the stationary or non-rotatable stator cover 15. The circumferential housing section 6 is in turn arranged on the first main bearing 16, so that the first main bearing 16 is arranged radially between the stator cover 15 and the housing section 6. A further main bearing 17 is arranged opposite between the housing section 6 and the cassette body 8. Acting radial forces are transmitted to the fixed drive axle 10 through the main bearing 17, then through the cassette body 8 and then through the bearing 25.

A further bearing (not shown) is also provided between the measuring sleeve of the sensor unit 20 and the drive axle 10. Accordingly, an acting radial force is transmitted into the housing section 6, then into the bearing 17, then into a freewheel body (if present), then into the measuring sleeve of the sensor unit 20 screwed to the freewheel body, then into a roller bearing and then into the drive axle 10. The further bearing 25 shown in FIGS. 5-8 serves the freewheel body and essentially no radial forces are introduced by the rider at this position.

The stator cover 15 has the shape of a bell and is arranged as far to the left as possible and extends through an inner or central recess 71 of the brake disk 7. The left-hand side of the drive device 5 shown in FIG. 5, on which the brake disk 7 is arranged, can also be referred to as the non-drive side. The right-hand side of the drive device 5 shown in FIG. 5, on which the cassette body 8 is arranged, can also be referred to as the drive side. The brake disk 7 is also attached, in particular screwed, to the circumferential housing section 6. The axial position of the brake disk 7 is unchanged compared to the previous embodiment example, as are the brake flanks of the brake disk 7. Due to the axial displacement of the electric motor and the stator cover 15, axial installation space is available inside the drive device 5 for the other or further components of the drive device 5.

In particular, the stator cover 15 is not enclosed on its axial outer side by the circumferential housing section 6, so that particularly efficient heat dissipation is achieved. The stator cover 15 is not tightly installed and encapsulated inside the circumferential housing section 6, but can dissipate the heat introduced from the stator 14 into the stator cover 15 directly to the circulating air of the outer area by means of heat conduction through the wall 151. Within the drive device 5, the heat is transferred from the stator 14 to the stator cover 15 mainly by means of heat conduction, but also by means of convection and heat radiation. The heat is then transferred from the stator cover 15 to the ambient air by means of convection and radiation.

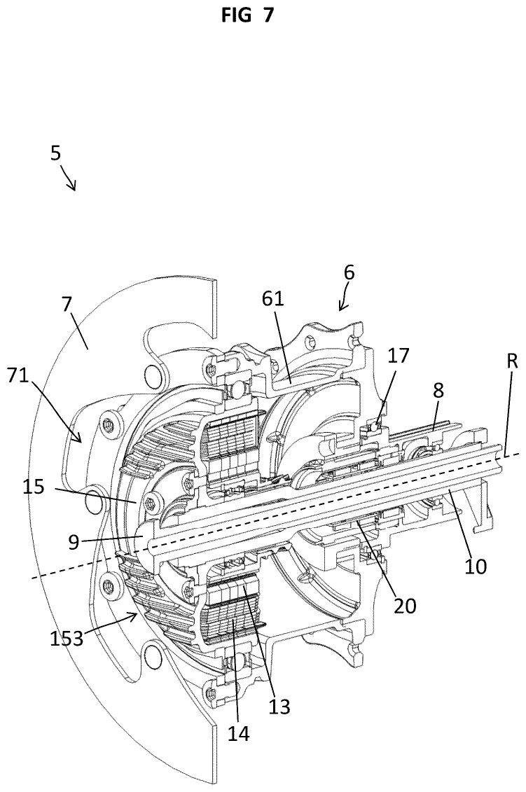

The heat dissipation can also be improved by the stator cover 15 having a cooling structure 153 on the axial outside with a plurality of ribs, which provide an enlarged surface at a distance from each other, around which the ambient air can flow (see FIG. 7).

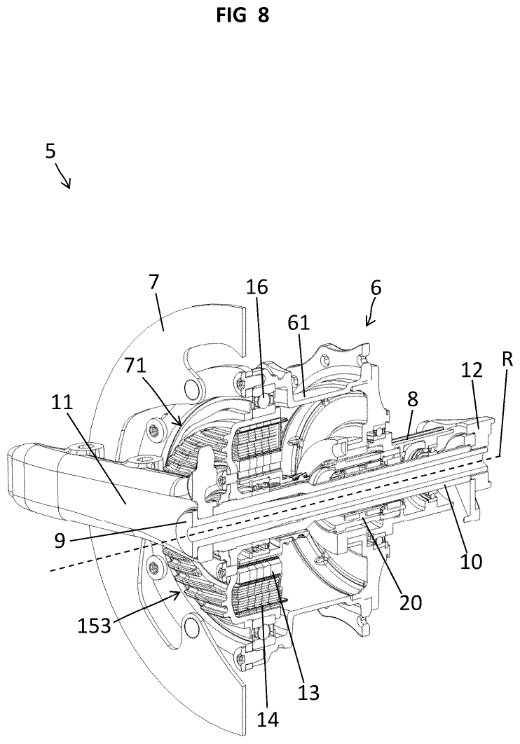

FIG. 8 shows the drive device 5 according to FIG. 7, where a possible arrangement and design of the left or first frame element 11 is also illustrated.

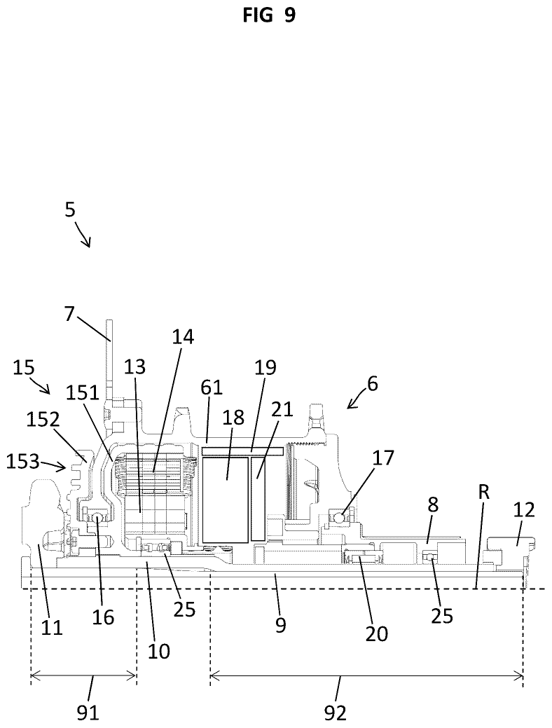

FIGS. 9-11 schematically show a further embodiment example of the drive device 5 for the electric bicycle 1 in various views. According to this embodiment example, the stator cover 15 comprises an extension section 152, which extends the wall 151 of the stator cover 15 and connects it to the outer area. Also by means of such an embodiment of the stator cover 15, which is surrounded by the housing section 6, a directed and timely heat dissipation by means of heat conduction can be set up.

The heat generated by the stator 14 during operation is transferred to the surrounding wall 151 of the stator cover 15 and conducted through the material under the first main bearing 16 into the extension section 152, from where the heat can be dissipated to the ambient air. Such heat dissipation is significantly more efficient than a heat transfer which, for example, has to overcome the wall 151 of the stator cover 15, the wall 61 of the housing section 6 and, in particular, the air gap between them. As described above, the extension section 152 can have the additional cooling structure 153 on the outside. The extension section 152 can be formed integrally with the wall 151 of the stator cover 15 or be coupled to the wall 151 as a separate extension piece. Preferably, the extension section 152 and the wall 151 are then made of the same material.

The stator cover 15 or the wall 151 and the extension section 152, if provided, are preferably made of aluminum or have aluminum. Aluminum, for example, has a significantly higher thermal conductivity compared to steel and also has weight advantages. Alternatively or additionally, one or more of the components described above could be made of magnesium or have magnesium, so that a low weight and reliable thermal conductivity of the drive device 5 can be achieved.

The hub axle has the thru axle 9 and the drive axle 10, each of which tapers towards the second end section 92, which enables simplified assembly and also provides installation space for the sensor unit 20.

The thru axle 9 is illustrated in FIGS. 2-11 with three sections, the two opposite end sections 91, 92 being connected to each other by a central section 93. The end sections 91, 92 each have a substantially constant diameter with respect to a radial direction transverse to the axis of rotation R, the diameter of the second end section 92 being smaller than that of the first end section 91. The central section 93 establishes a transition region between the two end sections 91, 92, the central section being designed such that it tapers continuously or in steps towards the second end section 92. Accordingly, the middle section 93 initiates a change in the circumference of the respective end sections 91, 92.

A length of the first end section 91 and/or a length of the second end section 92 along the axis of rotation R are designed in particular to match an extension of the electric motor 13, 14, the planetary gear 18 and/or the sensor unit 20. For example, the second end section 92 is twice as long as the first end section 91 in order to provide a correspondingly large amount of space for an elongated sensor unit 20 (see FIGS. 5-11). Alternatively, however, the first end section 91 can also be longer than the second end section 92, if the components of the drive device 5 permit or require this (see FIGS. 2-4). Alternatively, the first end section 91 and the second end section 92 can be of approximately the same length, provided that the components of the drive device 5 permit or require this.

For reasons of clarity, only the described sections 91, 92, 93 of the thru axle 9 are illustrated in FIGS. 2-11. However, the described properties and features can be transferred analogously to three sections of the drive axle 10, which are formed consecutively and can follow an outer contour of the thru axle 9 or, as illustrated in FIGS. 2-11, establish a free space 94 between the thru axle 9 and the drive axle 10. With reference to the illustrated FIGS. 2-11, a central section of the drive axle 10 thus begins further to the right than the central section of the thru axle 9. The free space 94 introduced in between can have a particularly beneficial effect on an assembly of the drive device 5, in which the thru axle 9 is inserted into the drive axle 10 and through the drive axle 10. The free space 94 thus provides a certain amount of assembly clearance and can, for example, somewhat mitigate tolerance accuracy requirements in the manufacture of the individual components of the drive device 5.

A reliable drive concept for electric bicycles can be realized by means of the drive device 5 described, which enables particularly efficient heat dissipation. In addition, an axially enlarged installation space can be created and greater rigidity and improved customer acceptance of the drive device 5 can be achieved. The drive device 5 is particularly suitable for mounting on the rear bicycle hub 3 and enables an advantageous drive system, particularly in terms of high efficiency.

1-15. (canceled)

16. A drive device comprising:
a motor unit with an electric motor configured to drive an electric bicycle;
a hub axle coupled to the electric motor;
a gearbox, which is configured to drive the electric bicycle and is rotatable about an axis of rotation, and which is coupled to the electric motor and to the hub axle and is configured to output a torque for driving the electric bicycle; and
a motor housing, in which the electric motor and the gearbox are arranged and through which the hub axle extends, the electric motor being shielded by an adjacent wall of the motor housing, which extends into an outer region outside the motor housing so that heat generated by the electric motor during operation of the electric bicycle is dissipated to the outer region by direct heat conduction through the wall.

17. The drive device according to claim 16, wherein the wall is directly adjacent to the outer region and the electric motor and is thereby shielded from the outer region only by a wall of the drive device.

18. The drive device according to claim 16, wherein the wall has an extension section, which connects the wall to the outer region in a thermally conductive manner.

19. The drive device according to claim 16, wherein the electric motor comprises a rotor and a stator, and wherein the stator is arranged in direct proximity to the wall of the motor housing.

20. The drive device according to claim 16, wherein the wall comprises a cooling structure comprising a plurality of fins arranged spaced apart from each other on an outer side of the wall.

21. The drive device according to claim 16, further comprising:
a slip ring arranged inside the motor housing with respect to the axis of rotation, wherein the slip ring comprises a first slip ring element and a second slip ring element, which contact each other radially and/or axially with respect to the axis of rotation and are coupled to a stator to provide a power supply to the stator for torque generation in an operation of the electric bicycle.

22. The drive device according to claim 16, wherein the motor housing is formed in two parts and comprises a circumferential housing section and a stator cover, which are rotatably coupled to each other with respect to the axis of rotation by a bearing, wherein the housing section surrounds the stator cover and the stator cover is rotationally fixed, wherein the housing section is rotatably coupled to the hub axle with respect to the axis of rotation, and wherein the stator cover extends axially along the axis of rotation to an outside of the housing section.

23. The drive device according to claim 22, further comprising:
a brake disk configured to brake the electric bicycle, wherein the brake disk is fixedly coupled to the circumferential housing portion and comprises an inner penetrating recess through which the stator cover extends axially along the axis of rotation.

24. The drive device according to claim 16, wherein the hub axle has, with respect to the axis of rotation, a first end portion and a second end portion, which are arranged to be coupled on opposite sides with respect to the axis of rotation to a respective outer frame element, and wherein the second end portion is formed narrower than the first end portion.

25. The drive device according to claim 24, further comprising:
a cassette body, which is coupled to the motor housing and surrounds the hub axle with respect to the axis of rotation, and which is configured to transmit a torque of a rider of the electric bicycle to the motor housing; and
a sensor unit coupled to the hub axle and arranged between the cassette body and the hub axle with respect to a radial direction transverse to the axis of rotation, the sensor unit configured to determine the torque.

26. The drive device according to claim 25, wherein the sensor unit is arranged in the narrower second end portion of the hub axle and the sensor unit and the second end portion are formed in coordination with each other.

27. The drive device according to claim 26, wherein the hub axle is formed in two parts and comprises a thru axle and a sleeve-shaped drive axle through which the thru axle extends.

28. The drive device according to claim 27, further comprising:
a first frame element and a second frame element, which are arranged on opposite sides outside the motor housing with respect to the axis of rotation and surround the hub axle, wherein the first and second frame elements are arranged in such a way that they predeterminedly brace the drive axle in cooperation with the thru axle.

29. The drive device according to claim 27, wherein the thru axle and the drive axle each taper along the axis of rotation in a direction towards the second end portion of the hub axle.

30. The drive device according to claim 16, further comprising:
a cassette body, which is coupled to the motor housing and surrounds the hub axle with respect to the axis of rotation, and which is configured to transmit a torque of a rider of the electric bicycle to the motor housing; and
a sensor unit coupled to the hub axle and arranged between the cassette body and the hub axle with respect to a radial direction transverse to the axis of rotation, the sensor unit configured to determine the torque.

31. The drive device according to claim 16, wherein the hub axle is formed in two parts and comprises a thru axle and a sleeve-shaped drive axle through which the thru axle extends.

32. The drive device according to claim 31, further comprising:
a first frame element and a second frame element, which are arranged on opposite sides outside the motor housing with respect to the axis of rotation and surround the hub axle, wherein the first and second frame elements are arranged in such a way that they predeterminedly brace the drive axle in cooperation with the thru axle.

33. The electric bicycle comprising:
a bicycle frame extending to a bottom bracket and to a bicycle hub; and
the drive device according to claim 16, is the drive device being coupled to the bicycle hub for driving the electric bicycle.
